(19) United States
(12) Patent Application Publication
(10) Pub. No.: US 2023/0414437 A1
(43) Pub. Date: Dec. 28, 2023

(54) WEARING MODULE AND MOTION ASSISTANCE APPARATUS COMPRISING SAME

(71) Applicant: SAMSUNG ELECTRONICS CO., LTD., Suwon-si (KR)

(72) Inventors: Minhyung LEE, Suwon-si (KR); Younbaek LEE, Suwon-si (KR); Segon ROH, Suwon-si (KR); Byungjune CHOI, Suwon-si (KR)

(21) Appl. No.: 18/463,809

(22) Filed: Sep. 8, 2023

Related U.S. Application Data
(63) Continuation of application No. PCT/KR2022/002419, filed on Feb. 18, 2022.

(30) Foreign Application Priority Data
Mar. 12, 2021 (KR) 10-2021-0032851
Jan. 3, 2022 (KR) 10-2022-0000526

(51) Int. Cl. A61H 1/02

(52) U.S. Cl. CPC A61H 1/0262; A61H 2201/164

(57) ABSTRACT

A wearing module may include: a cover; a main support portion including a main support portion body, and a main support portion head; a connection support portion comprising a connection support portion body, a length adjustment strap, and a sliding strap; and a bistable spring which may be connected to each of the main support portion and the connection support portion, and may be maintained in one of two stable states due to its recovery force. Other various embodiments are possible.

### CROSS-REFERENCE TO RELATED APPLICATIONS

This application is a continuation application of International Application No. PCT/KR2022/002419 designating the United States, filed on Feb. 18, 2022, in the Korean Intellectual Property Receiving Office and claiming priority to Korean Patent Application No. 10-2021-0032851, filed on Mar. 12, 2021, and to Korean Patent Application No. 10-2022-0000526, filed on Jan. 3, 2022, in the Korean Intellectual Property Office, the disclosures of which are incorporated by reference herein in their entireties.

### BACKGROUND

### Technical Field

Various example embodiments relate to a wearing module and/or a motion assistance apparatus including same.

### Description of Related Art

A motion assistance apparatus refers to a mechanism or a device that helps a patient, who cannot walk on his own due to various diseases, accidents, and the like, to perform exercises for rehabilitation treatment; and/or may refer to an apparatus for helping a user exercise. With the recent intensifying aging societies, a growing number of people experience inconvenience exercising or have difficulty with normal exercise due to malfunctioning joint issues, and there is increasing interest in motion assistance apparatus. A motion assistance apparatus is worn on the body of a user to assist the user to exercise, for example by providing necessary muscular strength that allows the user to walk so that the user may exercise normally.

In general, users wearing a motion assistance apparatus may be people with physical disabilities, and/or people who desire to exercise. The process of putting on a motion assistance apparatus itself may be difficult. There is a need for technology that allows users with physical disabilities to wear a motion assistance apparatus alone without the help of others.

The above description has been possessed or acquired by the inventor(s) in the course of conceiving the present disclosure and is not necessarily an art publicly known before the present application is filed.

### SUMMARY

According to various example embodiments, a wearing module may include a cover, a main support portion including a main support portion body having a curved shape and a main support portion head formed at one end of the main support portion body and connectable to the cover, a connection support portion including a connection support portion body rotatably connected, directly or indirectly, to the main support portion body, a length adjustment strap extending from the connection support portion body and caught by the cover, and a sliding strap of which at least a part is fixed to the length adjustment strap and slidable along the cover, and a bistable spring connected, directly or indirectly, to each of the main support portion and the connection support portion and maintained in at least one of a first stable state and a second stable state through recovery force.

In various example embodiments, a connection state of the cover and the main support portion may be determined based on a stable state of the bistable spring.

In various example embodiments, when the bistable spring is in the first stable state, a distance between the cover and the main support portion head may be greater than a distance between the cover and the main support portion head when the bistable spring is in the second stable state.

In various example embodiments, the bistable spring may be relatively in close contact with the main support portion body in the second stable state compared to the first stable state.

In various example embodiments, at least one of the main support portion and the connection support portion may further include an accommodating part to accommodate the bistable spring.

In various example embodiments, the main support portion may further include a main support extension portion connected, directly or indirectly, to the main support portion body and overlapped with the connection support portion in a state in which the cover is connected, directly or indirectly, to the main support portion.

In various example embodiments, the main support portion may further include a rotation axis configured to support the connection support portion to be rotatable.

In various example embodiments, when the bistable spring is in the first stable state, a distance between the bistable spring and the rotation axis may be greater than a distance between the bistable spring and the rotation axis when the bistable spring is in the second stable state.

In various example embodiments, the cover may include a cover body, a cover rod formed on, directly or indirectly, the cover body and configured to support the length adjustment strap, and a guide formed on, directly or indirectly, the cover body, spaced apart from the cover rod, and configured to guide sliding of the sliding strap.

In various example embodiments, the guide may be formed inside of the cover body.

In various example embodiments, while one end of the length adjustment strap slides in a first direction away from the cover body, the sliding strap may slide in a second direction opposite to the first direction.

In various example embodiments, the sliding strap may include a first sub-sliding strap fixed to the length adjustment strap and a second sub-sliding strap extending from the first sub-sliding strap, spaced apart from the length adjustment strap, and slidable along the guide.

In various example embodiments, the cover may further include a cover head extending from the cover body and a cover magnet disposed on, directly or indirectly, the cover head.

In various example embodiments, the main support portion may further include a main support portion head extending from the main support portion body and overlapping the cover head and a support portion magnet disposed on, directly or indirectly, the main support portion head.

According to various example embodiments, a motion assistance apparatus may include a main frame, an actuator disposed on, directly or indirectly, the main frame, a driving frame rotatable by receiving power from the actuator, and a wearing module connected, directly or indirectly, to the driving frame. The wearing module may include a cover connected, directly or indirectly, to the driving frame, a main support portion including a main support portion body having a curved shape and a main support portion head formed at one end of the main support portion body and connectable to the cover, a connection support portion including a connection support portion body rotatably connected, directly or indirectly, to the main support portion body, a length adjustment strap extending from the connection support portion body and caught by the cover, and a sliding strap of which at least a part is fixed to the length adjustment strap and slidable along the cover, and a bistable spring connected, directly or indirectly, to each of the main strap and a connection strap and maintained in one of two stable states through recovery force.

In various example embodiments, a connection state of the cover and the main support portion may be determined based on a stable state of the bistable spring.

In various example embodiments, the main support portion may further include a main support extension portion connected to the main support portion body and overlapped with the connection support portion in a state in which the cover is connected to the main support portion.

According to various example embodiments, a wearing module includes a cover, a main support portion having a curved shape, a connection support portion rotatably connected to the main support portion and connected to the cover, and a bistable spring connected to each of the main support portion and the connection support portion and maintained in one of two stable states through recovery force. A connection state of the cover and the main support portion may be determined based on a stable state of the bistable spring.

### BRIEF DESCRIPTION OF DRAWINGS

The above and other aspects, features, and advantages of certain embodiments of the present disclosure will be more apparent from the following detailed description, taken in conjunction with the accompanying drawings, in which:

FIG. 1 is a front view of a motion assistance apparatus according to an example embodiment.

FIG. 2 is a side view of the motion assistance apparatus according to an example embodiment.

FIG. 3 is a plan view of a wearing module in an opened state according to an example embodiment.

FIG. 4 is a plan view of the wearing module in a closed state according to an example embodiment.

FIG. 5 is a side view illustrating the wearing module according to an example embodiment.

FIG. 6 is a cross-sectional view of the wearing module according to an example embodiment.

FIG. 7 is a cross-sectional view of the wearing module according to an example embodiment.

FIG. 8 is a diagram schematically illustrating that the wearing module of the motion assistance apparatus is worn on the upper arm of a user according to an example embodiment.

### DETAILED DESCRIPTION

The following detailed structural or functional description is provided as an example only and various alterations and modifications may be made to examples. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the embodiments described above and an element having a common function. Unless otherwise mentioned, the descriptions of the embodiments may be applicable to the following embodiments and thus, duplicated descriptions will be omitted for conciseness.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the examples will be described in detail with reference to the accompanying drawings. When describing the embodiments with reference to the accompanying drawings, like reference numerals refer to like elements and any repeated description related thereto will be omitted.

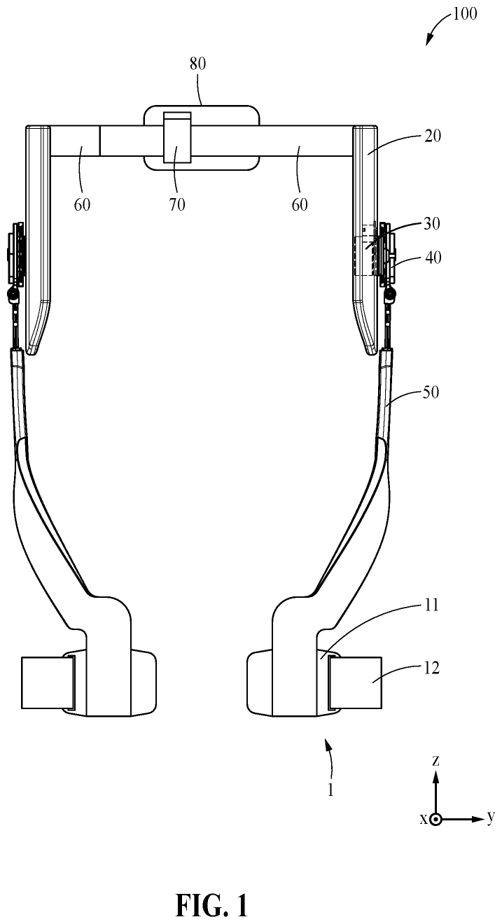

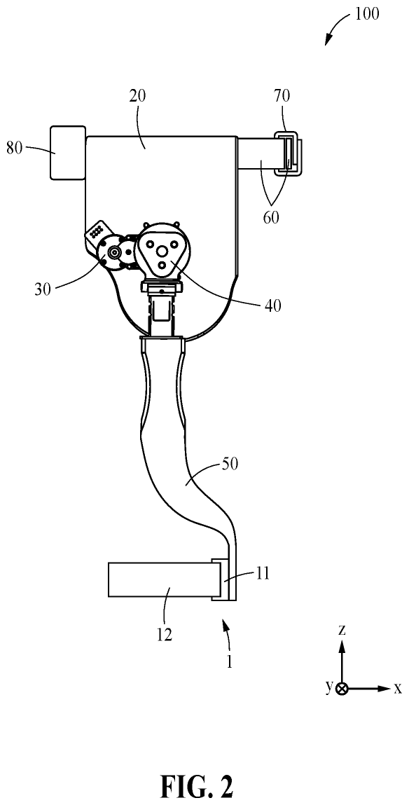

FIG. 1 is a front view of a motion assistance apparatus according to an embodiment and FIG. 2 is a side view of the motion assistance apparatus according to an embodiment.

Referring to FIGS. 1 and 2, a motion assistance apparatus 100 may be worn by a user and assist motion of the user. The user may be, for example, a human, an animal, or a robot but is not limited thereto. In addition, although FIG. 1 illustrates an example in which the motion assistance apparatus 100 assists motion of the thigh of the user, the motion assistance apparatus 100 may assist motion of another portion of the upper body, for example, the hand, the upper arm, and the lower arm of the user, or motion of another portion of the lower body, for example, the foot and the calf of the user. That is, the motion assistance apparatus 100 may assist motion of a portion of the user. Hereinafter, an example in which the motion assistance apparatus 100 assists motion of the thigh of the user is described.

In an embodiment, the motion assistance apparatus 100 may include a main body 80, a pair of main frames 20, one or a pair of belts 60, an auxiliary belt 70 connected, directly or indirectly, to one of the pair of belts 60, an actuator 30, a joint member 40, a driving frame 50, and a wearing module 1. The wearing module 1 may include a cover 11 and a support portion 12.

In an embodiment, the motion assistance apparatus 100 may support each of the proximal portion and the distal portion the user and may assist relative motion between the proximal portion and the distal portion. Components worn on the proximal portion of the user of the motion assistance apparatus 100 may be referred to as a ‘proximal wearing portion’ and components worn on the distal portion of the user may be referred to as a ‘distal wearing portion’. For example, the main body 80, the pair of main frames 20, the pair of belts 60, and the auxiliary belt 70 of the components of the motion assistance apparatus 100 may correspond to the proximal wearing portion and the wearing module 1 may correspond to the distal wearing portion. For example, the proximal wearing portion may be worn on the waist or the pelvis of the user and the distal wearing portion may be worn on the thigh or the calf of the user. It should be noted that positions in which the proximal wearing portion and the distal wearing portion are worn are not limited thereto. For example, the proximal wearing portion may be worn on the torso or the shoulder of the user and the distal wearing portion may be worn on the upper arm or the lower arm of the user.

In an embodiment, the main body 80 may accommodate a controller (not shown) to control the actuator 30 and a power supply portion (not shown) to supply power to the actuator 30 therein. For example, the main body 80 may be disposed on the back of the user based on a state in which the motion assistance apparatus 100 is worn on the body of the user.

In an embodiment, the pair of main frames 20 may be connected, directly or indirectly, to the main body 80. The main frame 20 may support a portion of the body of the user. The main frame 20 may contact at least a part of an outer surface of the user. The main frame 20 may have a shape surrounding the outer surface of the user. The main frame 20 may be curved in a shape corresponding to a contact portion of the user. That is, the main frame 20 may include a curved surface in contact with the user. For example, the main frame 20 may support the waist of the user.

In an embodiment, the pair of belts 60 may be connected, directly or indirectly, to the pair of main frames 20, respectively. The pair of belts 60 may maintain a shape extending forward (x direction) before the user wears the motion assistance apparatus 100 and need not prohibit the user from entering inside of the pair of main frames 20. On the other hand, in a state in which the user enters inside of the pair of main frames 20, the pair of belts 60 may be deformed and as shown in the drawings, may enclose a front portion of the user. The main body 80, the pair of main frames 20, and the pair of belts 60 may entirely surround the circumference of the user.

In an embodiment, the pair of auxiliary belts 70 may fix the pair of belts 60 to each other while the pair of belts 60 overlap each other. For example, one belt of the pair of belts 60 may enclose the other belt with the pair of auxiliary belts 70.

In an embodiment, the actuator 30 may provide power to be transmitted to the joint member 40. The actuator 30 may include a motor that generates power by receiving voltage or current from the power supply portion. For example, the actuator 30 may be disposed in a lateral direction of the joint member 40. That is, a rotation axis of the actuator 30 and a rotation axis of the joint member 40 may be disposed to be spaced apart from each other. In this case, a height protruding from the user may decrease, in comparison to a case in which the actuator 30 and the joint member 40 share a rotation axis. On the other hand, unlike the drawings, the actuator 30 may be disposed to be spaced apart from the joint member 40. In this case, a power transmission module to transmit power from the actuator 30 to the joint member 40 may be provided. The power transmission module may be a rotary body, such as a gear, or a longitudinal member, such as a wire, a cable, a string, a rubber band, a spring, a belt, or a chain. However, in an embodiment, the position and the power transmission structure of the actuator 30 are not limited.

In an embodiment, the joint member 40 may receive power from the actuator 30 to assist motion of the joint portion of the user. The joint member 40 may be disposed at a position corresponding to the joint portion of the user. The joint member 40 may be disposed on one side of the main frame 20. One side of the joint member 40 may be connected to the actuator 30 and another side thereof may be connected to the driving frame 50, the cover 11, and the support portion 12. The joint member 40 may be rotated by the power received from the actuator 30. An encoder to measure a rotation angle of the joint member 40 may be disposed on one side of the joint member 40.

In an embodiment, the driving frame 50 may transmit assistance force to assist motion of a portion of the user. Here, the assistance force may be understood as force acting in the same direction as a direction of motion of a portion of the user. That is, the assistance force may be understood as force obtained by excluding force in a direction intersecting with the direction of the motion of the portion of the user from among force on the portion of the user. One end portion of the driving frame 50 may be connected to the joint member 40 and may be rotated. The other end portion of the driving frame 50 may be connected to the cover 11 and may transmit assistance force to a portion of the user. For example, the driving frame 50 may push or pull the thigh of the user. The driving frame 50 may extend in the longitudinal direction of the thigh of the user. The driving frame 50 may be bent to surround at least a part of the circumference of the thigh of the user. For example, an upper portion of the driving frame 50 may cover a portion of the body of the user facing the side (+y direction or −y direction) and a lower portion of the driving frame 50 may cover a portion of the body of the user facing the front (+x direction).

In an embodiment, the cover 11 may apply assistance force to a portion of the user. For example, the cover 11 may be disposed on, directly or indirectly, one side of the thigh of the user to push or pull the thigh of the user. The cover 11 may be disposed on, directly or indirectly, the front surface of the thigh of the user. The cover 11 may be disposed in the circumferential direction of the thigh of the user. The cover 11 may extend to both sides around the other end portion of the driving frame 50. The cover 11 may include a curved surface corresponding to the thigh of the user.

In an embodiment, the support portion 12 may be connected, directly or indirectly, to one side of the cover 11. For example, the support portion 12 may be disposed to surround at least a part of the circumference of the thigh of the user to prevent or reduce a chance of the thigh of the user from separating from the driving frame 50.

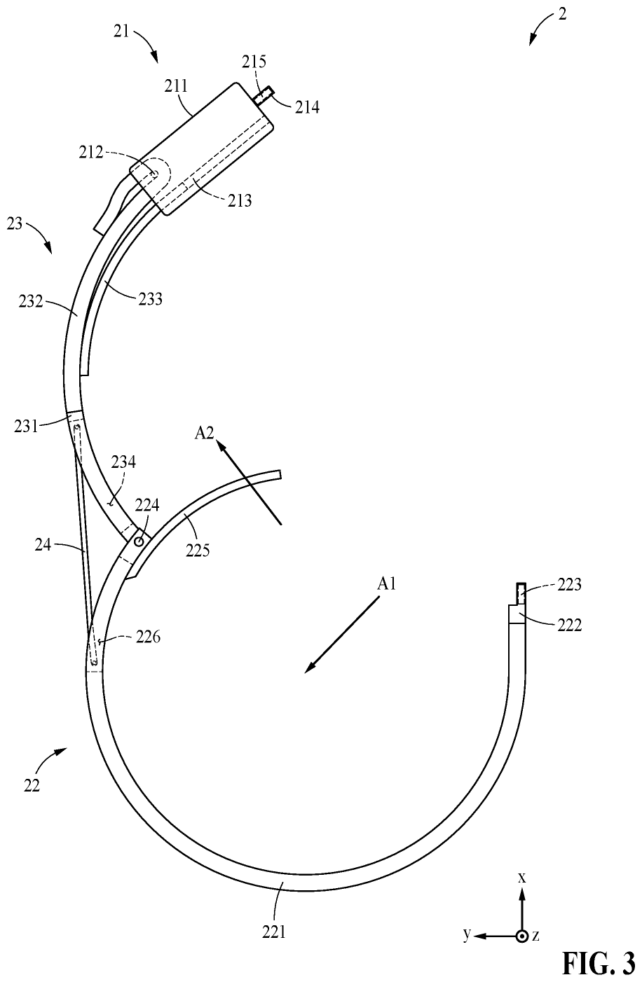

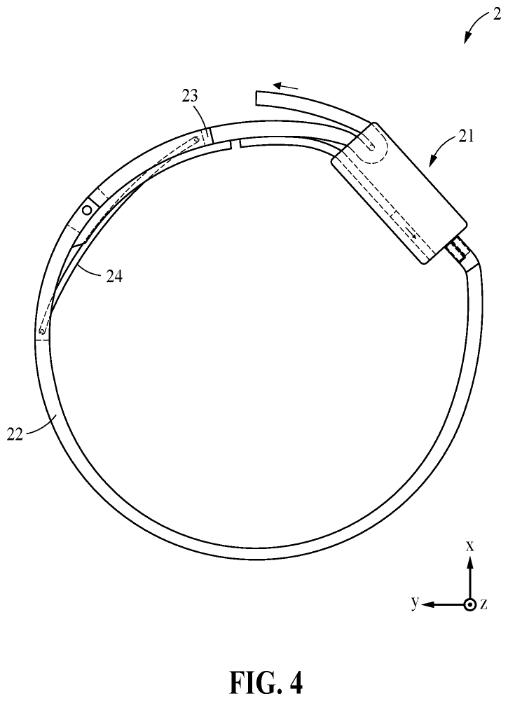

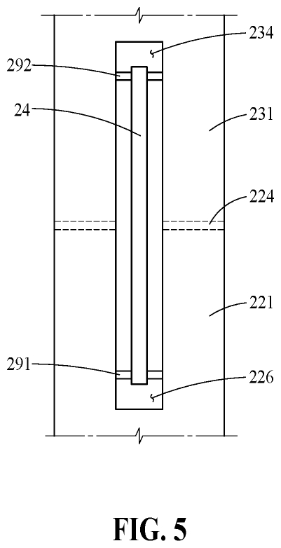

FIG. 3 is a plan view of a wearing module in an opened state according to an embodiment, FIG. 4 is a plan view of the wearing module in a closed state according to an embodiment, and FIG. 5 is a side view illustrating the wearing module according to an embodiment.

Referring to FIGS. 3 to 5, a wearing module 2 may support a portion of the body of the user. For example, the wearing module 2 may support at least one of the thigh, shin, upper arm, and lower arm of the user. The wearing module 2 may be driven in a semi-automatic manner. The wearing module 2 may be in one of an opened state and a closed state. In the opened state, the wearing module 2 may accommodate the thigh of the user. For example, the thigh of the user may enter inside of the wearing module 2 in a direction of arrow A1. The thigh of the user may press a main support portion 22 in a direction of arrow A2. The force in the direction of arrow A2 may switch the wearing module 2 from an opened state to a closed state. A detailed description of the state transition is described in detail below with reference to a bistable spring 24. The user may wear the wearing module 2 without a certain operation of fastening the wearing module 2. For example, the user may switch the wearing module 2 to a closed state only by entering the thigh of the user to the wearing module 2. The wearing module 2 may include components for maintaining a closed loop shape in a closed state. For example, the wearing module 2 may include a pair of magnets connected to each other. The wearing module 2 may include a cover 21, the main support portion 22, a connection support portion 23, and the bistable spring 24.

In an embodiment, the cover 21 may transmit power of a driving frame (e.g., the driving frame 50 of FIG. 2) to the main support portion 22. The power of the driving frame 50 may be transmitted to the main support portion 22 through the cover 21 and may finally assist motion of the joint of the user. The cover 21 may cover a portion of the body of the user. For example, the cover 21 may be disposed on the front of the thigh of the user. Although not shown, the inner surface of the cover 21 may have a curved shape surrounding a partial area of the front of the thigh. Here, the inner surface may refer to a surface facing the body of the user. The cover 21 may include a cover body 211, a cover rod 212, a guide 213, a cover head 214, and a cover magnet 215.

In an embodiment, the cover body 211 may be connected, directly or indirectly, to a driving frame. The cover body 211 may be formed of, for example, a plastic material.

In an embodiment, the cover rod 212 may be formed on, directly or indirectly, the cover body 211. For example, the cover rod 212 may be formed inside of the cover body 211. For example, the longitudinal direction of the cover rod 212 may be parallel to the z-axis direction. The cover rod 212 may support the connection support portion 23. For example, at least a part of the connection support portion 23 may enter inside of the cover body 211 and be caught by the cover rod 212. One side of the connection support portion 23 may be maintained in a state of being caught by the cover rod 212. For example, a length adjustment strap of the connection support portion 23 may be caught by the cover rod 212.

In an embodiment, the guide 213 may be formed on, directly or indirectly, the cover body 211. For example, the guide 213 may be spaced apart from the cover rod 212. The guide 213 may guide the movement of the connection support portion 23. A sliding strap of the connection support portion 23 may slide along the guide 213.

In an embodiment, the guide 213 may be formed inside of the cover body 211. According to this shape, it is possible to block interference between the sliding strap and the body of the user at a position where the sliding strap slides. The sliding strap may freely slide without being caught by the body of the user.

In an embodiment, the cover head 214 may extend from the cover body 211. The cover head 214 may accommodate the cover magnet 215.

In an embodiment, the cover magnet 215 may be disposed on, directly or indirectly, the cover head 214. For example, the cover magnet 215 may be disposed inside of the cover head 214. In another example, at least a part of the cover magnet 215 may be exposed to the outside of the cover head 214. The cover magnet 215 may interact with a magnet provided on the connection support portion 23. For example, when the wearing module 2 is switched to a closed state, the cover magnet 215 may prevent or reduce a chance of the connection support portion 23 from separating from the cover 21 by applying the magnet provided on the connection support portion 23 and attractive force.

In an embodiment, the main support portion 22 may have a curved shape. The main support portion 22 may enclose the thigh of the user. For example, the main support portion 22 may apply power transmitted from a driving frame (e.g., the driving frame 50 of FIG. 2) to the body of the user. The main support portion 22 may include a main support portion body 221, a main support portion head 222, a support portion magnet 223, a rotation axis 224, a main support extension portion 225, and a first accommodating part 226.

In an embodiment, the main support portion body 221 may open in one direction when the wearing module 2 is in an opened state. The main support portion body 221 may accommodate a portion of the body of the user through an opening. For example, the thigh of the user may enter inside of the main support portion body 221 in the direction of arrow A1. The opening of the main support portion body 221 may be closed by the connection support portion 23 and the cover 21 when the wearing module 2 is in a closed state.

In an embodiment, the main support portion head 222 may be formed on, directly or indirectly, one end of the main support portion body 221. The main support portion head 222 may be connected, directly or indirectly, to the cover 21. For example, the main support portion head 222 may be detachably connected to the cover 21.

In an embodiment, the support portion magnet 223 may be accommodated inside of the main support portion head 222. The support portion magnet 223 may interact with the cover magnet 215. When the wearing module 2 is switched from an opened state to a closed state, the support portion magnet 223 may approach the cover magnet 215.

In an embodiment, the rotation axis 224 may be connected to the main support portion body 221 and rotatably support the connection support portion 23. For example, the rotation axis 224 may be formed parallel to the z-axis direction in a longitudinal direction.

In an embodiment, the main support extension portion 225 may be connected to the main support portion body 221. The main support extension portion 225 may overlap with the connection support portion 23 in a state in which the cover 21 is connected to the main support portion 22, that is, in a closed state. The main support extension portion 225 may assist in more efficiently applying force from the body of the user to the wearing module 2. For example, although not shown, a hole for preventing or reducing interference with the bistable spring 24 may be provided in the main support extension portion 225. In another example, the main support extension portion 225 may be provided at a position that does not interfere with a moving path of the bistable spring 24. According to this structure, unintentional interference between the bistable spring 24 and the main support extension portion 225 may be prevented or reduced.

In an embodiment, the first accommodating part 226 may accommodate the bistable spring 24. For example, the first accommodating part 226 may be formed on, directly or indirectly, the main support portion body 221. For example, the first accommodating part 226 may be formed through the main support portion body 221. The first accommodating part 226 may prevent or reduce a chance of the bistable spring 24 and the main support portion 22 from interfering with each other. Even when the bistable spring 24 is provided, since the main support portion 22 includes the first accommodating part 226, the bistable spring 24 and the main support portion 22 may not interfere with each other. In another example, the first accommodating part 226 may be recessed from the outer surface of the main support portion body 221.

In an embodiment, the connection support portion 23 may be rotatably connected to the main support portion 22 and may be connected to the cover 21. The connection support portion 23 may rotate around the rotation axis 224. The connection support portion 23 may include a connection support portion body 231, a length adjustment strap 232, a sliding strap 233, and a second accommodating part 234.

In an embodiment, the connection support portion body 231 may be rotatably connected to the main support portion body 221. For example, the connection support portion body 231 may be rotatably connected to the rotation axis 224 that is fixed to the main support portion body 221. The connection support portion body 231 may be formed of a rigid material.

In an embodiment, the length adjustment strap 232 may extend from the connection support portion body 231 and be caught by the cover 21. One end of the length adjustment strap 232 may pass through the cover 21. A portion of the length adjustment strap 232 passing through the cover 21 may be detachably connected to the outer surface of the length adjustment strap 232. For example, the portion of the length adjustment strap 232 passing through the cover 21 may be fixed using a Velcro method. A Velcro structure (not shown) may be provided on the outer surface of the length adjustment strap 232.

In an embodiment, at least a part of the sliding strap 233 may be fixed to the length adjustment strap 232. A portion of the sliding strap 233 that is not fixed to the length adjustment strap 232 may slide along the cover 21. The sliding strap 233 may slide along the guide 213.

In an embodiment, while one end of the length adjustment strap 232 slides in a first direction away from the cover body 211, the sliding strap 233 may slide in a second direction opposite to the first direction. The length adjustment strap 232 may relatively move with respect to the cover 21 regardless of a state of the wearing module 2. For example, the user may adjust the circumference of the wearing module 2 by pulling the length adjustment strap 232 before the user wears the wearing module 2. In another example, the user may adjust the circumference of the wearing module 2 by pulling the length adjustment strap 232 in a state in which the user wears the wearing module 2. The user may assist in tightly connecting the wearing module 2 to the body by pulling the length adjustment strap 232.

In an embodiment, the second accommodating part 234 may accommodate the bistable spring 24. For example, the second accommodating part 234 may be formed on, directly or indirectly, the connection support portion body 231. For example, the second accommodating part 234 may be formed through the connection support portion body 231. The second accommodating part 234 may prevent or reduce a chance of the bistable spring 24 and the connection support portion 23 from interfering with each other. Even when the bistable spring 24 is provided, since the connection support portion 23 includes the second accommodating part 234, the bistable spring 24 and the connection support portion 23 may not interfere with each other. In another example, the second accommodating part 234 may be recessed from the outer surface of the connection support portion body 231.

In an embodiment, the bistable spring 24 may be connected to each of the main support portion 22 and the connection support portion 23 and may be maintained in one of two stable states through recovery force. For example, the bistable spring 24 may be provided in one of a first stable state and a second stable state. When the bistable spring 24 is deformed into a shape other than the first stable state and the second stable state, the bistable spring 24 may be restored to one of the first stable state and the second stable state by recovery force.

In an embodiment, the wearing module 2 may determine a connection state of the cover 21 and the main support portion 22 based on a stable state of the bistable spring 24. “Based on” as used herein covers based at least on.

In an embodiment, compared to when the bistable spring 24 is in the first stable state, in the second stable state, the bistable spring 24 may be relatively in close contact with the main support portion body 221. For example, the bistable spring 24 may be in close contact with the main support portion body 221 while having a shape bent in the same direction as that of the main support portion body 221. According to this shape, in a state where the user wears the wearing module 2, a protruding height protruding outward from the main support portion 22 and/or the connection support portion 23 may decrease and the wearing module 2 may be configured compactly.

In an embodiment, when the bistable spring 24 is in the first stable state, the distance between the cover 21 and the main support portion head 222 may be greater than the distance between the cover 21 and the main support portion head 222 when the bistable spring 24 is in the second stable state. For example, when the bistable spring 24 is in the second stable state, the cover magnet 215 and the support portion magnet 223 may provide enough attractive force to maintain a state in which the cover head 214 and the main support portion head 222 are in contact with each other.

In an embodiment, the bistable spring 24 may be relatively in close contact with the main support portion body 221 in the second stable state compared to the first stable state.

In an embodiment, when the bistable spring 24 is in the first stable state, the distance between the bistable spring 24 and the rotation axis 224 may be greater than the distance between the bistable spring 24 and the rotation axis 224 when the bistable spring 24 is in the second stable state.

In an embodiment, a first support member 291 for supporting one side of the bistable spring 24 may be provided on the main support portion body 221 and a second support member 292 for supporting the bistable spring 24 may be provided on the connection support portion body 231.

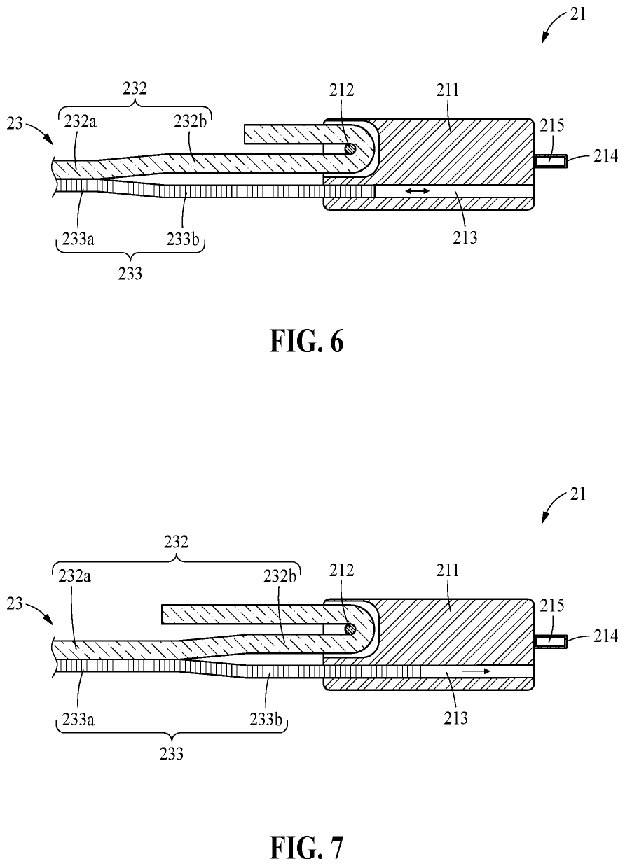

FIG. 6 is a cross-sectional view of the wearing module according to an embodiment and FIG. 7 is a cross-sectional view of the wearing module according to an embodiment.

Referring to FIGS. 6 and 7, the cover 21 and the connection support portion 23 may be provided in a connected state. The cover 21 may include the cover body 211, the cover rod 212, the guide 213, the cover head 214, and the cover magnet 215. The connection support portion 23 may include the connection support portion body 231, the length adjustment strap 232, and the sliding strap 233.

In an embodiment, at least a part of the length adjustment strap 232 and a part the sliding strap 233 may be fixed to each other. The length adjustment strap 232 may include a first sub-length adjustment strap 232a that is fixed to the sliding strap 233 and a second sub-length adjustment strap 232b that is spaced apart from the sliding strap 233. The sliding strap 233 may include a first sub-sliding strap 233a that is fixed to the length adjustment strap 232 and a second sub-sliding strap 233b that is spaced apart from the length adjustment strap 232.

In an embodiment, the second sub-length adjustment strap 232b may be caught by the cover rod 212. The second sub-sliding strap 233b may slide along the guide 213.

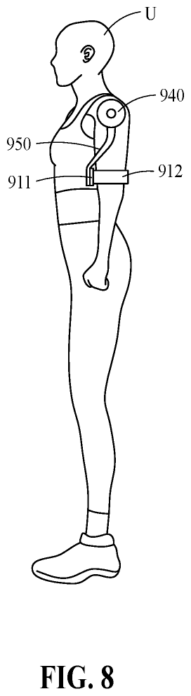

FIG. 8 is a diagram schematically illustrating that a wearing module of the motion assistance apparatus is worn on the upper arm of a user according to an embodiment.

Referring to FIG. 8, a wearing module of a motion assistance apparatus may be worn on the upper arm of a user U. For example, a joint member 940 of the motion assistance apparatus may be provided near the shoulder of the user U and a driving frame 950 may be connected to the joint member 940 and disposed along the upper arm of the user U.

In an embodiment, a cover 911 may be connected to the end portion of the driving frame 950 to support a portion of the upper arm of the user. A support portion 912 may be connected to the cover 911. The support portion 912 may be connected to the cover 911 to support the other portions of the upper arm. An elastic layer (not shown) may be provided inside of the cover 911 and the support portion 912. The joint member 940 may rotate the driving frame 950 by receiving power from an actuator (not shown).

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and/or equivalents of the claims are within the scope of the following claims.

1. A wearing module for supporting a portion of a body of a user, the wearing module comprising:
a cover;
a main support portion comprising a main support portion body configured to include a curved shape and a main support portion head formed at an end of the main support portion body and connectable to the cover;
a connection support portion comprising a connection support portion body rotatably and/or pivotally connected to the main support portion body, a length adjustment strap extending from the connection support portion body, and a sliding strap of which at least a part is fixed to the length adjustment strap and configured to be slidable along the cover; and
a bistable spring connected to each of the main support portion and the connection support portion and configured to be maintained in a first stable state and/or a second stable state through recovery force.

2. The wearing module of claim 1, wherein the main support portion body is configured to surround at least a portion of a thigh and/or arm of the user, and wherein a connection state of the cover and the main support portion is based on a stable state of the bistable spring.

3. The wearing module of claim 1, wherein the bistable spring is configured so that, when the bistable spring is in the first stable state, a distance between the cover and the main support portion head is greater than a distance between the cover and the main support portion head when the bistable spring is in the second stable state.

4. The wearing module of claim 1, wherein the bistable spring is configured to be in relatively close contact with the main support portion body in the second stable state compared to the first stable state.

5. The wearing module of claim 1, wherein at least one of the main support portion and the connection support portion further comprises an accommodating part, comprising a support, to accommodate the bistable spring.

6. The wearing module of claim 1, wherein the main support portion further comprises a main support extension portion connected to the main support portion body and overlapped with the connection support portion in a state in which the cover is connected to the main support portion.

7. The wearing module of claim 1, wherein the main support portion further comprises a rotation axis configured to support the connection support portion to be rotatable.

8. The wearing module of claim 7, wherein the bistable spring is configured so that, when the bistable spring is in the first stable state, a distance between the bistable spring and the rotation axis is greater than a distance between the bistable spring and the rotation axis when the bistable spring is in the second stable state.

9. The wearing module of claim 1, wherein the cover comprises:
a cover body;
a cover rod formed on the cover body and configured to support the length adjustment strap; and
a guide formed on the cover body, spaced apart from the cover rod, and configured to guide sliding of the sliding strap.

10. The wearing module of claim 9, wherein the guide is formed inside of the cover body.

11. The wearing module of claim 9, wherein the length adjustment strap and the sliding strap are configured so that, while one end of the length adjustment strap slides in a first direction away from the cover body, the sliding strap slides in a second direction opposite to the first direction.

12. The wearing module of claim 9, wherein the sliding strap comprises:
a first sub-sliding strap fixed to the length adjustment strap; and
a second sub-sliding strap extending from the first sub-sliding strap, spaced apart from the length adjustment strap, and slidable along the guide.

13. The wearing module of claim 9, wherein the cover further comprises:
a cover head extending from the cover body; and
a cover magnet disposed on the cover head.

14. The wearing module of claim 13, wherein the main support portion further comprises:
a main support portion head extending from the main support portion body and overlapping the cover head; and
a support portion magnet disposed on the main support portion head.

15. A wearing module for supporting a portion of a body of a user of a wearable assistance apparatus, the wearing module comprising:
a cover configured to be mounted proximate a thigh and/or arm of the user;
a main support portion comprising a main support portion body configured to include a curved shape and a main support portion head formed proximate an end of the main support portion body and connectable to the cover, wherein the main support portion body is configured to surround at least a portion of the thigh and/or arm of the user;
a connection support portion comprising a connection support portion body rotatably and/or pivotally associated with the main support portion body, a length adjustment strap, and a sliding strap of which at least a part is fixed to the length adjustment strap and configured to be slidable along the cover; and
a bistable spring connected to each of the main support portion and the connection support portion and configured to be maintained in a first stable state and/or a second stable state.

16. The wearing module of claim 15, wherein the wearable assistance apparatus is a wearable walking assistance apparatus configured to be worn by the user, and wherein a connection state of the cover and the main support portion is based on a stable state of the bistable spring.

17. The wearing module of claim 15, wherein the bistable spring is configured so that, when the bistable spring is in the first stable state, a distance between the cover and the main support portion head is greater than a distance between the cover and the main support portion head when the bistable spring is in the second stable state.

18. The wearing module of claim 15, wherein the bistable spring is configured to be relatively in close contact with the main support portion body in the second stable state compared to the first stable state.
